(19) United States
(12) Patent Application Publication
(10) Pub. No.: US 2009/0189584 A1
(43) Pub. Date: Jul. 30, 2009

(54) VOLTAGE REGULATOR

(76) Inventor: Teruo Suzuki, Chiba-shi (JP)

Correspondence Address: Brinks Hofer Gilson & Lione/Seiko Instruments Inc., P.O. Box 10395, Chicago, IL, 60611, US

(21) Appl. No.: 12/357,762

(22) Filed: Jan. 22, 2009

(30) Foreign Application Priority Data
Jan. 24, 2008 (JP) JP2008-013477

(51) Int. Cl. G05F 1/10

(52) U.S. Cl. 323/284

(57) ABSTRACT

Provided is a voltage regulator capable of reducing fluctuation of an output current even when an output terminal thereof is short-circuited. In a case where the output terminal of the voltage regulator is short-circuited, an output current (Iout) of the voltage regulator is limited and fixed to a limit current value. When an output voltage (Vout) of the voltage regulator decreases to have a value equal to or smaller than not a detection voltage value (Vref3) of a reference voltage circuit (34) but a detection voltage value (Vref2) of a reference voltage circuit (31), a second limit operation in which the output voltage (Iout) is further limited to be decreased is set. Further, in a case where the output terminal is short-circuited and then reset, when the output voltage (Vout) has a value equal to or larger than not the detection voltage value (Vref2) but the detection voltage value (Vref3), the second limit operation is canceled.

### RELATED APPLICATIONS

This application claims priority under 35 U.S.C. § 119 to Japanese Patent Application No. JP2008-013477 filed on Jan. 24, 2008, the entire content of which is hereby incorporated by reference.

### BACKGROUND OF THE INVENTION

1. Field of the Invention

The present invention relates to a voltage regulator.

2. Description of the Related Art

First, a conventional voltage regulator is described. FIG. 3 is a diagram illustrating the conventional voltage regulator. FIG. 4 is a graph illustrating an output voltage with respect to an output current in the conventional voltage regulator.

In FIG. 3, an output transistor 71 outputs an output voltage Vout based on an input voltage Vin and a control voltage Vc of an amplifier circuit 74. When the output voltage Vout of the voltage regulator decreases, the output voltage Vout is divided by a voltage divider circuit 72, whereby a divided voltage Vfb output by the voltage divider circuit 72 also decreases. The amplifier circuit 74 compares the divided voltage Vfb with a reference voltage Vref1 which is generated by a reference voltage circuit 73. When the divided voltage Vfb is lower than the reference voltage Vref1, the control voltage Vc also decreases. Then, the output transistor 71 is turned on, and the output voltage Vout increases. When the output voltage Vout decreases, owing to a feedback control as described above, the output voltage Vout increases, thereby being controlled to have a constant desired voltage value.

Further, when the output voltage Vout increases, owing to the similar feedback control described above, the output voltage Vout decreases, and hence the output voltage Vout is controlled to have a constant desired voltage value.

When an output terminal of the voltage regulator is short-circuited, as illustrated in FIG. 4, an output current Iout of the voltage regulator increases. When the output current Iout reaches a limit current value, an overcurrent protection circuit 75 operates so that the output current Iout decreases to have a value equal to or smaller than the limit current value. Specifically, when the output current Iout increases to thereby reach the limit current value, the output current Iout is limited and fixed to the limit current value (first limit operation). When the output voltage Vout decreases to have a detection voltage value, the output current Iout is further limited by the overcurrent protection circuit 75 and decreases (second limit operation) to have a short-circuit current value. Then, the output voltage Vout decreases to be 0 volts.

Further, when the output terminal is short-circuited and then reset, as illustrated in FIG. 4, the output voltage Vout increases from 0 volts. When the output voltage Vout has a value equal to or larger than the detection voltage value, the second limit operation is canceled, whereby the output current Iout increases. When the output current Iout reaches the limit current value, the output current Iout is limited and fixed to the limit current value (first limit operation). After that, when the output voltage Vout increases to have a desired voltage value and the output current Iout decreases to have a value smaller than the limit current value, the first limit operation is canceled (for example, see JP 2003-186554 A (FIGS. 5 and 6)).

However, in a case where the output terminal is short-circuited and therefore the output voltage Vout has a value approximate to the detection voltage value, the overcurrent protection circuit 75 sets or cancels the second limit operation with respect to the output current Iout based on one detection voltage value. As a result, the output current Iout at a time at which the output terminal is short-circuited is not made stable. In this case, there is a risk that the output current Iout does not have a short-circuit current value but has an unexpected current value, whereby the output voltage Vout becomes 0 volts.

### SUMMARY OF THE INVENTION

The present invention has been made in view of the above-mentioned problem, and provides a voltage regulator capable of reducing fluctuation of an output current even when an output terminal thereof is short-circuited.

In order to solve the above-mentioned problem, the present invention provides a voltage regulator including: an output transistor; a voltage divider circuit; a reference voltage circuit; an amplifier circuit; an overcurrent protection circuit; and a voltage detection circuit, the output transistor outputting an output voltage of the voltage regulator based on an input voltage of the voltage regulator and a control voltage of the amplifier circuit, the voltage divider circuit dividing the output voltage to output a divided voltage, the reference voltage circuit generating a reference voltage, the amplifier circuit controlling the output transistor so that the output voltage has a constant desired voltage value, by outputting the control voltage which increases the output voltage when the divided voltage is smaller than the reference voltage and by outputting the control voltage which decreases the output voltage when the divided voltage is larger than the reference voltage, the overcurrent protection circuit operating, when an output current of the voltage regulator reaches a limit current value, to limit the output current to have a value equal to or smaller than the limit current value, the voltage detection circuit operating so that the overcurrent protection circuit further limits the output current when a voltage based on the output voltage decreases from a value larger than a first detection voltage value to a value equal to or smaller than the first detection voltage value, and so that the overcurrent protection circuit relaxes limitation of the output current to make the output current have a value equal to or smaller than the limit current value when the voltage based on the output voltage increases from a value smaller than a second detection voltage value to a value equal to or larger than the second detection voltage value.

In the present invention, in a case where the output terminal of the voltage regulator is short-circuited, the output current of the voltage regulator is limited and fixed to the limit current value. When the output voltage of the voltage regulator decreases to have a value equal to or smaller than the first detection voltage value, a second limit operation in which the output current is further limited to be decreased is set. Further, in a case where the output terminal is short-circuited and then reset, when the output voltage has a value equal to or larger than the second detection voltage value, the second limit operation is canceled. In a case where a detection voltage value in the second limit operation in the case where the output terminal is short-circuited and a detection voltage value for the cancellation of the second limit operation in the case where the output terminal is short-circuited and then reset are equal to each other, when the output voltage has a value approximate to the detection voltage value, the second limit operation is set or canceled with respect to the output current based on one detection voltage value, and hence the output current at a time at which the output terminal is short-circuited is made unstable. However, in the present invention, the detection voltage value in the second limit operation in the case where the output terminal is short-circuited and the detection voltage value for the cancellation of the second limit operation in the case where the output terminal is short-circuited and then reset are different from each other, whereby the output current at the time at which the output terminal is short-circuited is made stable.

### BRIEF DESCRIPTION OF THE DRAWINGS

In the accompanying drawings:

FIG. 1 is a diagram illustrating a voltage regulator;

FIG. 2 is a graph illustrating an output voltage with respect to an output current;

FIG. 3 is a diagram illustrating a conventional voltage regulator; and

FIG. 4 is a graph illustrating an output voltage with respect to an output current in the conventional voltage regulator.

### DETAILED DESCRIPTION OF THE PREFERRED EMBODIMENT

Hereinafter, with reference to the drawings, an embodiment of the present invention is described.

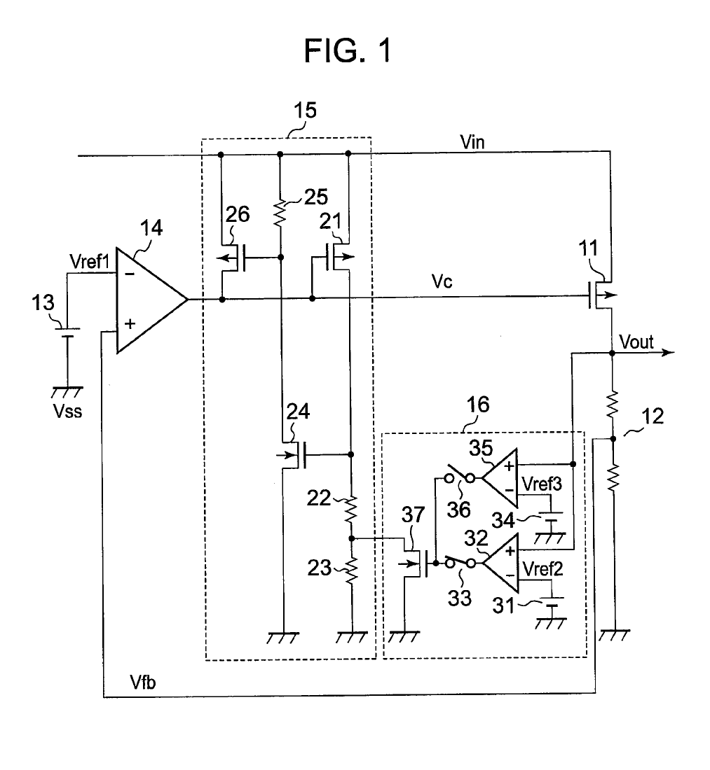

First, a structure of a voltage regulator is described. FIG. 1 is a diagram illustrating the voltage regulator.

The voltage regulator includes an output transistor 11, a voltage divider circuit 12, a reference voltage circuit 13, an amplifier circuit 14, an overcurrent protection circuit 15, and a voltage detection circuit 16. The overcurrent protection circuit 15 includes a PMOS transistor 21, resistors 22 and 23, an NMOS transistor 24, a resistor 25, and a PMOS transistor 26. The voltage detection circuit 16 includes a reference voltage circuit 31, a comparator 32, a switch 33, a reference voltage circuit 34, a comparator 35, a switch 36, and an NMOS transistor 37.

The output transistor 11 has a gate connected to an output terminal of the amplifier circuit 14, to a gate of the PMOS transistor 21, and to a drain of the PMOS transistor 26. The output transistor 11 has a source connected to an input terminal of the voltage regulator, and a drain connected to an output terminal of the voltage regulator. The voltage divider circuit 12 is provided between the output terminal of the voltage regulator and a ground terminal, and has an output terminal connected to a non-inverting input terminal of the amplifier circuit 14. The reference voltage circuit 13 is provided between an inverting input terminal of the amplifier circuit 14 and the ground terminal. The PMOS transistor 21 has a source connected to the input terminal of the voltage regulator, and a drain connected to one terminal of the resistor 22 and to a gate of the NMOS transistor 24. Another terminal of the resistor 22 is connected to one terminal of the resistor 23 and to a drain of the NMOS transistor 37. Another terminal of the resistor 23 is connected to the ground terminal. The NMOS transistor 24 has a source connected to the ground terminal, and a drain connected to one terminal of the resistor 25 and to a gate of the PMOS transistor 26. Another terminal of the resistor 25 is connected to the input terminal of the voltage regulator. The PMOS transistor 26 has a source connected to the input terminal of the voltage regulator. The reference voltage circuit 31 is provided between an inverting input terminal of the comparator 32 and the ground terminal. The comparator 32 has a non-inverting input terminal connected to the output terminal of the voltage regulator, and an output terminal connected to one terminal of the switch 33. Another terminal of the switch 33 is connected to a gate of the NMOS transistor 37 and to one terminal of the switch 36. The reference voltage circuit 34 is provided between an inverting input terminal of the comparator 35 and the ground terminal. The comparator 35 has a non-inverting input terminal connected to the output terminal of the voltage regulator, and an output terminal connected to another terminal of the switch 36. The NMOS transistor 37 has a source connected to the ground terminal.

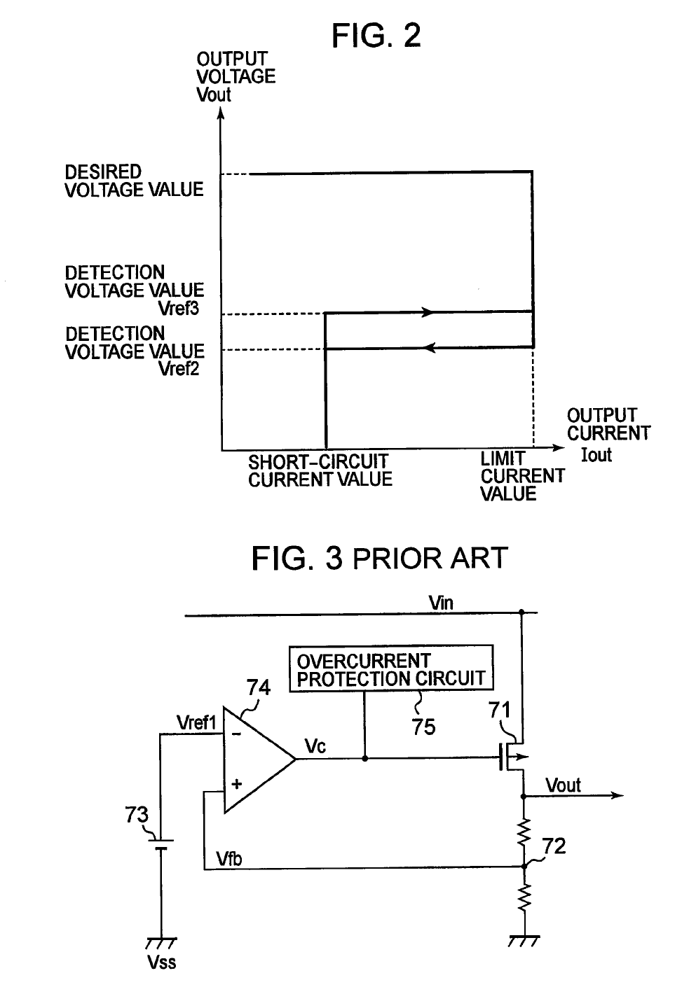

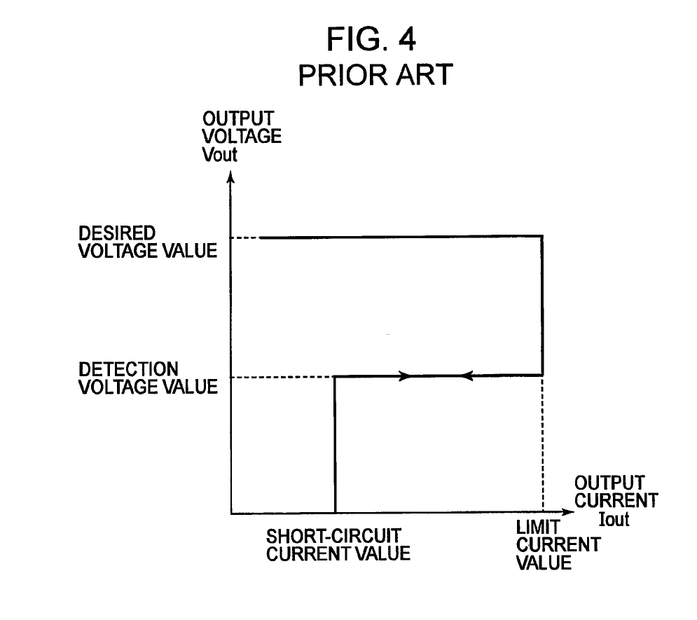

Next, an operation of the voltage regulator is described. FIG. 2 is a graph illustrating an output voltage with respect to an output current.

(Case where Output Voltage VOUT of Voltage Regulator Decreases)

In this case, the output transistor 11 outputs an output voltage Vout based on an input voltage Vin and a control voltage Vc of the amplifier circuit 14. The output voltage Vout is divided by the voltage divider circuit 12, and hence a divided voltage Vfb output by the voltage divider circuit 12 also decreases. The amplifier circuit 14 compares the divided voltage Vfb with a reference voltage Vref1 generated by the reference voltage circuit 13. When the divided voltage Vfb decreases below the reference voltage Vref1, the control voltage Vc also decreases. Then, the output transistor 11 is turned on and the output voltage Vout increases. When the output voltage Vout decreases, owing to a feedback control as described above, the output voltage Vout increases. Accordingly, the output voltage Vout is controlled to have a constant desired voltage value.

(Case where Output Voltage Vout of Voltage Regulator Increases)

Owing to the similar feedback control described above, the output voltage Vout decreases, and accordingly the output voltage Vout is controlled to have a constant desired voltage value.

(Case where Output Terminal of Voltage Regulator is Short-Circuited)

As illustrated in FIG. 2, an output current Iout of the voltage regulator increases, and when the output current Iout reaches a limit current value, the overcurrent protection circuit 15 and the voltage detection circuit 16 operate so that the output current Iout decreases to a value equal to or smaller than the limit current value. Specifically, when the output current Iout increases to reach the limit current value, the output current Iout is limited and fixed to the limit current value (first limit operation). Then, when the voltage detection circuit 16 detects that the output voltage Vout decreases to thereby have a value equal to or smaller than not a detection voltage value Vref3 of the reference voltage circuit 34 but a detection voltage value Vref2 of the reference voltage circuit 31, the output current Iout is further limited to be decreased by the overcurrent protection circuit 15 (second limit operation). Then, the output current Iout has a short-circuit current value, and the output voltage Vout decreases to be 0 volts.

(Case where Output Terminal of Voltage Regulator is Short-Circuited and then Reset)

As illustrated in FIG. 2, the output voltage Vout increases from 0 volts. When the output voltage Vout has not the detection voltage value Vref2 or larger but the detection voltage value Vref3 or larger, the second limit operation is canceled and the output current Iout increases. When the output current Iout reaches the limit current value, the output current Iout is limited and fixed to the limit current value (first limit operation). After that, the output voltage Vout increases to have a desired voltage value. When the output current Iout decreases to have a value smaller than the limit current value, the first limit operation is canceled.

Next, operations of the overcurrent protection circuit 15 and the voltage detection circuit 16 are described. FIG. 2 is the graph illustrating an output voltage with respect to an output current.

(Case where Output Terminal of Voltage Regulator is Short-Circuited)

In this case, immediately after the input voltage Vin is applied, the switch 33 is turned on and the switch 36 is turned off. The output voltage Vout has a value equal to or larger than the detection voltage value Vref2, and hence the output terminal of the comparator 32 is in a high state. Accordingly, the NMOS transistor 37 is turned on and only the resistor 22 is present between the gate of the NMOS transistor 24 and the ground terminal.

As illustrated in FIG. 2, when the output current Iout increases, a drain current of the PMOS transistor 21 also increases, whereby a voltage generated in the resistor 22 increases.

After the output current Iout reaches the limit current value and the voltage generated in the resistor 22 reaches a threshold voltage of the NMOS transistor 24, the NMOS transistor 24 is turned on and allows a drain current to flow. Then, a voltage is generated in the resistor 25 to thereby be a threshold voltage of the PMOS transistor 26, and hence the PMOS transistor 26 is also turned on. Then, the control voltage Vc increases and the output transistor 11 is turned off, whereby the output current Iout is fixed to the limit current value (first limit operation). Further, the output transistor 11 is turned off to decrease the output voltage Vout.

After that, when the output voltage Vout decreases from a value larger than the detection voltage value Vref2 to a value equal to or smaller than not the detection voltage value Vref3 but the detection voltage value Vref2, the output terminal of the comparator 32 becomes a low state. Specifically, the comparator 32 detects that the output voltage Vout has a value equal to or smaller than the detection voltage value Vref2. Accordingly, the NMOS transistor 37 is turned off and the resistors 22 and 23 are present between the gate of the NMOS transistor 24 and the ground terminal. Even when a small amount of the output current Iout and the drain current of the PMOS transistor 21 flow, the NMOS transistor 24 and the PMOS transistor 26 are likely to be turned on. In other words, the overcurrent protection circuit 15 operates so as to further limit the output current Iout. Further, the switch 33 is turned off, and the switch 36 is turned on.

Owing to the above-mentioned operation of the NMOS transistor 37, the output current Iout decreases (second limit operation). The output current Iout has a short-circuit current value, and the output voltage Vout decreases to be 0 volts.

(Case where Output Terminal of Voltage Regulator is Short-Circuited and then Reset)

In this case, the switch 33 is turned off and the switch 36 is turned on. The output voltage Vout has a value equal to or smaller than the detection voltage value Vref3, and hence the output terminal of the comparator 32 is in a low state. Accordingly, the NMOS transistor 37 is turned off and the resistors 22 and 23 are present between the gate of the NMOS transistor 24 and the ground terminal.

As illustrated in FIG. 2, the output voltage Vout increases from 0 volts.

After that, when the output voltage Vout increases from a value smaller than the detection voltage value Vref3 to a value equal to or larger than not the detection voltage value Vref2 but the detection voltage value Vref3, the output terminal of the comparator 35 becomes a high state. Specifically, the comparator 35 detects that the output voltage Vout has a value equal to or larger than the detection voltage value Vref3. Accordingly, the NMOS transistor 37 is turned on and only the resistor 22 is present between the gate of the NMOS transistor 24 and the ground terminal. When a small amount of the output current Iout and the drain current of the PMOS transistor 21 flow, the NMOS transistor 24 and the PMOS transistor 26 are unlikely to be turned on. In other words, the overcurrent protection circuit 15 operates so as to relax the limitation of the output current Iout and to make the output current Iout have a value equal to or smaller than the limit current value. Further, the switch 33 is turned on, and the switch 36 is turned off.

Owing to the above-mentioned operation of the NMOS transistor 37, the second limit operation is canceled and the output current Iout increases. When the output current Iout reaches the limit current value, as described above, the output current Iout is limited and fixed to the limit current value (first limit operation). Then, the output transistor 11 is turned on. After that, when the output voltage Vout increases to be a desired voltage value and the output current Iout decreases below the limit current value, the first limit operation is canceled.

Through the above-mentioned operation, in the case where the output terminal of the voltage regulator is short-circuited, the output current Iout of the voltage regulator is limited and fixed to the limit current value, and when the output voltage Vout of the voltage regulator decreases to have a value equal to or smaller than not the detection voltage value Vref3 of the reference voltage circuit 34 but the detection voltage value Vref2 of the reference voltage circuit 31, the second limit operation in which the output current Iout is further limited to be decreased is set. Further, in the case where the output terminal is short-circuited and then reset, when the output voltage Vout has a value equal to or larger than not the detection voltage value Vref2 but the detection voltage value Vref3, the second limit operation is canceled. In a case where a detection voltage value in the second limit operation in the case where the output terminal is short-circuited and a detection voltage value for the cancellation of the second limit operation in the case where the output terminal is short-circuited and then reset are equal to each other, when the output voltage Vout has a value approximate to the detection voltage value, the second limit operation is set or canceled with respect to the output current Iout based on one detection voltage value, whereby the output current Iout at a time at which the output terminal is short-circuited is made unstable. However, in the present invention, a detection voltage value in the second limit operation in the case where the output terminal is short-circuited and a detection voltage value for the cancellation of the second limit operation in the case where the output terminal is short-circuited and then reset are different from each other, whereby the output current Iout at the time at which the output terminal is short-circuited is made stable.

Here, the output voltage Vout of the voltage regulator mounted in various products tends to be small. Along with this, the detection voltage values Vref2 and Vref3 also tend to be small. Then, the output current Iout at the time at which the output terminal is short-circuited is liable to be unstable. However, with the voltage regulator according to the present invention, the output current Iout at the time at which the output terminal is short-circuited is made stable.

Note that the resistor 22 and the resistor 25 may be configured as variable resistors. In this case, when resistance values of the resistors 22 and 25 become large, the limit current value becomes small, and when the resistance values of the resistors 22 and 25 become small, the limit current value becomes large. As a result, the limit current value can be adjusted after a semiconductor device is manufactured.

Further, the output voltage Vout is input into the comparator 32 and the comparator 35, but the divided voltage Vfb may be input into the comparator 32 and the comparator 35. In this case, the detection voltage values Vref2 and Vref3 are made small by an amount of the divided voltage Vfb obtained by dividing the output voltage Vout.

What is claimed is:

1. A voltage regulator for regulating an output voltage to a constant voltage, comprising:
a voltage regulator responsive to a control signal to regulate the output voltage;
a constant voltage circuit configured to define a first and a second discrete voltage levels;
a current control circuit operable in a first state where it regulates an output current to not higher than a current limit to protect the voltage regulator from overcurrent and in a second state where it regulates the output current to lower than the current limit under a short-circuited condition; and
a voltage detection circuit responsive under the short circuit condition to a descent of the output voltage across the first voltage level to switch the current control circuit from the first state into the second state, and responsive, after the voltage regulator is released from the short-circuit condition, to an ascent of the output voltage across the second voltage to switch the control circuit from the second state into the first state.

2. The voltage regulator according to claim 1, wherein the voltage detection circuit comprises:
a first comparator configured to detect a descent of the output voltage across the first voltage level;
a second comparator configured to detect an ascent of the output voltage across the second voltage;
a selection switch configured to alternatively effect the first and second comparators, wherein the selection switch makes the second comparator effective and the first comparator ineffective after the current control circuit is switched into the second state from the first state and makes the first comparator effective and the second comparator ineffective after the current control circuit is switched into the first state from the second state; and
a state switching switch driven by the first comparator to switch the current control circuit from the first state into the second state and driven by the second comparator to switch the control circuit from the second state into the first state.

3. The voltage regulator according to claim 2, wherein the current control circuit comprises:
a current restrictor configured to variably restrict the output current; and
a restrictor control circuit operable by the state switching switch to make the current restrictor increase restriction on the output current when the state switching switch switches the current control circuit from the first state into the second state and to make the current restrictor case the restriction on the output current when the state switching switch switches the current control circuit from the second state into the first state.

4. The voltage regulator according to claim 3, wherein the voltage regulator comprises an output transistor whose source is connected to an input terminal of the voltage regulator and whose drain is connected to an output terminal of the voltage regulator, and the output transistor is responsive to the control signal supplied at its gate to regulate the output voltage.

5. The voltage regulator according to claim 4, wherein the state switching switch comprises a first NMOS transistor whose gate is selectively connectable via the selection switch to the first comparator and the second comparator and whose source is grounded, and
the first NMOS transistor is turned off when the first comparator detects a descent of the output voltage across the first voltage level and turned on when the second comparator detects an ascent of the output voltage across the second voltage.

6. The voltage regulator according to claim 5, wherein the restrictor control circuit comprises a first PMOS transistor whose source is connected to the input terminal of the voltage regulator and whose drain is connected to the ground via serially connected two resistors,
the first PMOS transistor whose gate is connected to the gate of the output transistor, such that the first PMOC transistor, responsive to the control signal supplied to its gate, changes an amount of current flowing through its drain, and
the first NMOS transistor has a drain connected to between the two resistors and bypasses one of the resistors to the ground when turned on to thereby control a voltage at the drain of the first PMOS transistor.

7. The voltage regulator according to claim 6, wherein the current restrictor comprises:
a second NMOS transistor whose drain is connected to the input of the voltage regulator via a resistor, whose source is connected to the ground and whose gate is connected to the drain of the first PMOS transistor, such that the second NMOS, responsive to the voltage at the drain of the first PMOS transistor, changes a voltage at its drain; and
a second PMOS transistor whose source is connected to the input terminal of the voltage regulator, whose drain is connected to the gate of the output transistor, and whose gate is connected to the drain of the second NMOS transistor, such that the second PMOS transistor, responsive to the voltage at the drain of the second NMOS transistor, changes the control signal supplied to the gate of the output transistor to thereby change the output voltage.
